(19) United States
(12) Patent Application Publication
(10) Pub. No.: US 2007/0080915 A1
(43) Pub. Date: Apr. 12, 2007

(54) Display driver, electro-optical device, electronic instrument, and drive method

(75) Inventor: Hiroaki Nomizo, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/543,442

(22) Filed: Oct. 5, 2006

(30) Foreign Application Priority Data
Oct. 7, 2005 (JP) 2005-295389
Jun. 22, 2006 (JP) 2006-172232

(51) Int. Cl. G09G 3/36

(52) U.S. Cl. 345/89

(57) ABSTRACT

A display driver includes a display memory 100 which stores grayscale data, a correction calculation section 110 which corrects input grayscale data in units of dots forming one pixel, a line buffer 130 which stores corrected data of one scan line corrected by the correction calculation section 110, and a driver section 140 which drives an electro-optical device based on the grayscale data read from the display memory 100 or the corrected data read from the line buffer 130. The correction calculation section 140 generates the corrected data based on the grayscale data read from the display memory 100 and the input grayscale data. The driver section 140 drives the electro-optical device based on the corrected data, and then drives the electro-optical device based on the grayscale data read from the display memory.

Japanese Patent Application No. 2005-295389 filed on Oct. 7, 2005, and Japanese Patent Application No. 2006-172232 filed on Jun. 22, 2006, are hereby incorporated by reference in their entirety.

### BACKGROUND OF THE INVENTION

The present invention relates to a display driver, an electro-optical device, an electronic instrument, and a drive method.

As a liquid crystal panel (electro-optical device in a broad sense) used for an electronic instrument such as a portable telephone, a simple matrix type liquid crystal panel and an active matrix type liquid crystal panel using a switching device such as a thin film transistor (hereinafter abbreviated as “TFT”) are known.

The simple matrix type liquid crystal panel allows power consumption to be easily reduced in comparison with the active matrix type liquid crystal panel. However, the simple matrix type liquid crystal panel has disadvantages in that it is difficult to increase the number of colors and to display a video image. The active matrix type liquid crystal panel is suitable for increasing the number of colors and displaying a video image. However, the active matrix type liquid crystal panel has a disadvantage in that it is difficult to reduce power consumption.

In recent years, a multicolor video image display has been increasingly demanded for a portable electronic instrument such as a portable telephone in order to provide a high-quality image. Therefore, the active matrix type liquid crystal panel has been increasingly used instead of the simple matrix type liquid crystal panel.

In related-art technology, a constant voltage obtained by converting grayscale data into a grayscale voltage is applied to a source line of a liquid crystal panel. Therefore, when the amount of change between the grayscale voltage in the current frame and the grayscale voltage in the frame one frame (one vertical scan period) before the current frame is large, a residual image may occur when displaying a video image.

In order to prevent such a deterioration in the image quality, JP-A-2004-302023 discloses a halftone drive technology for an interlace method, for example. In the technology disclosed in JP-A-2004-302023, an image signal of which the luminance is higher than the original grayscale is generated as the image signal for an odd-numbered frame and written into the first line, and an interpolation image signal of which the luminance is lower than the above image signal is then generated and written into the second line. An interpolation image signal of which the luminance is lower than the original grayscale is generated as the image signal for the subsequent even-numbered frame and written into the first line, and an image signal of which the luminance is higher than the above image signal is generated and written into the second line. This achieves a temporal and spatial half-tone drive.

JP-A-2004-334153 discloses technology in which each pixel is displayed as a combination of display pixels with grayscale values differing from the grayscale value of the pixel. This allows each pixel to be displayed as the combination of pixels with different grayscale values even if pixels with the same grayscale value continue, whereby occurrence of crosstalk can be reduced.

### SUMMARY

According to one aspect of the invention, there is provided a display driver for driving an electro-optical device based on grayscale data, the display driver comprising:

a display memory which stores grayscale data of at least one frame;

a correction calculation section which corrects input grayscale data supplied to the display memory in units of dots forming one pixel;

a line buffer which stores corrected data of one scan line corrected by the correction calculation section; and

a driver section which drives the electro-optical device based on the grayscale data read from the display memory or the corrected data read from the line buffer;

the correction calculation section reading the grayscale data of one scan line from the display memory, and generating the corrected data based on the grayscale data and the input grayscale data of one scan line, on condition that the input grayscale data has been supplied; and

the driver section driving the electro-optical device based on the corrected data in a first scan period, and driving the electro-optical device based on the grayscale data read from the display memory in each of one or more scan periods subsequent to the first scan period.

According to another aspect of the invention, there is provided an electro-optical device comprising:

a plurality of scan lines;

a plurality of data lines;

a plurality of pixels specified by the scan lines and the data lines;

a scan driver which scans the scan lines; and

the above display driver which drives the data lines based on the grayscale data.

According to a further aspect of the present invention, there is provided an electronic instrument comprising the above the electro-optical device.

According to a further aspect of the present invention, there is provided a method of driving a display driver for driving an electro-optical device based on grayscale data, the display driver including a display memory which stores grayscale data of at least one frame, the method comprising:

reading grayscale data of one scan line from the display memory on condition that input grayscale data has been supplied to the display memory;

generating corrected data by correcting the input grayscale data in units of dots forming one pixel based on the grayscale data and the input grayscale data of one scan line; and

driving the electro-optical device based on the corrected data in a first scan period, and driving the electro-optical device based on the grayscale data read from the display memory in each of one or more scan periods subsequent to the first scan period.

### BRIEF DESCRIPTION OF THE SEVERAL VIEWS OF THE DRAWING

FIG. 1 is a block diagram of a configuration example of a liquid crystal device according to one embodiment of the invention.

FIG. 2 is a block diagram of another configuration example of a liquid crystal device according to one embodiment of the invention.

FIG. 3 is a block diagram of a configuration example of a gate driver shown in FIG. 1 or 2.

FIG. 4 is a block diagram of a configuration example of a source driver according to one embodiment of the invention.

FIG. 5 is a timing diagram of an operation example of the source driver shown in FIG. 4.

FIG. 6 is a view showing an outline of a configuration of a correction calculation section shown in FIG. 4.

FIG. 7 is a view illustrative of the grayscale characteristics of a display panel.

FIG. 8 is a view illustrative of a grayscale 0 to 31 table of an LUT shown in FIG. 6.

FIG. 9 is a view illustrative of a correction value shown in FIG. 8 in detail.

FIG. 10 is a view illustrative of an example of a correction value stored in an LUT according to one embodiment of the invention.

FIG. 11 is a schematic view of a connection example of the source driver shown in FIG. 4.

FIG. 12 is a view showing an example of a change in luminance of a pixel driven by a source driver in a comparative example of one embodiment of the invention.

FIG. 13 is a view showing an example of a change in luminance of a pixel driven by the source driver according to one embodiment of the invention.

FIG. 14 is a timing diagram of a detailed operation example of the source driver shown in FIG. 4.

FIG. 15 is a view showing a detailed configuration example of the source driver shown in FIG. 4.

FIG. 16 is a block diagram of a configuration example of an electronic instrument according to one embodiment of the invention.

### DETAILED DESCRIPTION OF THE EMBODIMENT

Embodiments of the invention are described below. Note that the embodiments given below do not in any way limit the scope of the invention laid out in the claims. Note that all of the elements of the embodiments given below should not necessarily be taken as essential requirements for the invention.

A display panel displays images of 60 frames within one second, for example. On the other hand, grayscale data is supplied to a display driver which drives the display panel at a rate of 15 frames per second, for example. Therefore, it is difficult to supply the grayscale data of 60 frames within one second.

The technology disclosed in JP-A-2004-302023 relates to an interlace method. In the case of applying the interlace method, when an image signal of which the luminance is higher than the original grayscale or an interpolation image signal of which the luminance is lower than the original grayscale is generated in each frame, processing load and power consumption are increased.

The technology disclosed in JP-A-2004-334153 has a problem in which the combination pattern of the display pixels becomes complicated, whereby the configuration of the display driver becomes complicated. Moreover, it becomes difficult to adjust the grayscale characteristics corresponding to the type of display panel.

According to the following embodiments, a display driver of which the grayscale characteristics can be flexibly changed using a simple configuration and which can eliminate a residual image at low power consumption, an electro-optical device, an electronic instrument, and a drive method may be provided.

According to one embodiment of the invention, there is provided a display driver for driving an electro-optical device based on grayscale data, the display driver comprising:

a display memory which stores grayscale data of at least one frame;

a correction calculation section which corrects input grayscale data supplied to the display memory in units of dots forming one pixel;

a line buffer which stores corrected data of one scan line corrected by the correction calculation section; and

a driver section which drives the electro-optical device based on the grayscale data read from the display memory or the corrected data read from the line buffer;

the correction calculation section reading the grayscale data of one scan line from the display memory, and generating the corrected data based on the grayscale data and the input grayscale data of one scan line, on condition that the input grayscale data has been supplied; and

the driver section driving the electro-optical device based on the corrected data in a first scan period, and driving the electro-optical device based on the grayscale data read from the display memory in each of one or more scan periods subsequent to the first scan period.

In the display driver according to this embodiment,

the input grayscale data may be stored in a memory area of the display memory in which the grayscale data of one scan line read by the correction calculation section has been stored.

In the display driver according to this embodiment,

the correction calculation section may calculate a difference between the input grayscale data and the grayscale data of one scan line read from the display memory in dot units, may calculate a correction value corresponding to the difference, and may generate the corrected data based on the input grayscale data and the correction value.

In the display driver according to this embodiment,

the correction calculation section may include:

a first calculation section which calculates the difference between the input grayscale data and the grayscale data of one scan line read from the display memory in dot units;

a look-up table which stores the correction value corresponding to the difference; and

a second calculation section which generates the corrected data based on the input grayscale data and the correction value; and

the corrected data generated by the second calculation section may be stored in the line buffer.

According to one of the above embodiments, the grayscale voltage corresponding to the corrected data is applied in the first scan period, and the grayscale voltage corresponding to the grayscale data read from the display memory is applied in one or more scan periods subsequent to the first scan period. Therefore, a highly accurate grayscale representation can be achieved by increasing the response speed of the liquid crystal and then applying an accurate grayscale voltage so that the luminance corresponding to the original grayscale is obtained.

Since it suffices that the correction calculation section operates only when the input grayscale data is supplied, an increase in power consumption can be suppressed. Therefore, power consumption can be reduced as the supply rate of the input grayscale data becomes lower.

In the display driver according to this embodiment, a different correction value may be stored in the look-up table corresponding to the input grayscale data even if the difference is the same.

According to this embodiment, since the corrected data corresponding to the grayscale characteristics which do not have a linear relationship can be easily adjusted and accurately generated, the grayscale characteristics can be flexibly changed using a simple configuration while achieving the above effects.

In the display driver according to this embodiment,

an input address corresponding to the difference may be generated corresponding to the input grayscale data; and

the look-up table may output the correction value corresponding to the input address.

The display driver according to this embodiment may comprise:

a data latch which holds the grayscale data read from the display memory or the corrected data read from the line buffer;

wherein the driver section may drive the electro-optical device using the data held by the data latch.

According to this embodiment, corrected data for the next scan period can be provided during the period in which the driver section drives the display panel. Therefore, a sufficient driving time can be provided for the driver section.

The display driver according to this embodiment may comprise:

a display control circuit which generates a second vertical synchronization signal which provides reference timing for the driver section to drive the electro-optical device based on a first vertical synchronization signal input together with the input grayscale data;

wherein the driver section may drive the electro-optical device based on the corrected data on condition that the first vertical synchronization signal has been input, and then drives the electro-optical device based on the grayscale data read from the display memory in synchronization with the second vertical synchronization signal.

According to another embodiment of the invention, there is provided an electro-optical device comprising:

a plurality of scan lines;

a plurality of data lines;

a plurality of pixels specified by the scan lines and the data lines;

a scan driver which scans the scan lines; and

the above display driver which drives the data lines based on the grayscale data.

According to this embodiment, an electro-optical device can be provided which includes a display driver of which the grayscale characteristics can be flexibly changed using a simple configuration and which can eliminate a residual image at low power consumption. Therefore, an electro-optical device can be provided which can prevent deterioration in the image quality and achieve low power consumption.

According to a further embodiment of the invention, there is provided an electronic instrument comprising the above electro-optical device.

According to the above embodiment, an electronic instrument can be provided which includes an electro-optical device including a display driver of which the grayscale characteristics can be flexibly changed using a simple configuration and which can eliminate a residual image at low power consumption. Therefore, an electronic instrument can be provided which can prevent deterioration in the image quality and achieve low power consumption.

According to a further embodiment of the invention, there is provided a method of driving a display driver for driving an electro-optical device based on grayscale data, the display driver including a display memory which stores grayscale data of at least one frame, the method comprising:

reading grayscale data of one scan line from the display memory on condition that input grayscale data has been supplied to the display memory;

generating corrected data by correcting the input grayscale data in units of dots forming one pixel based on the grayscale data and the input grayscale data of one scan line; and

driving the electro-optical device based on the corrected data in a first scan period, and driving the electro-optical device based on the grayscale data read from the display memory in each of one or more scan periods subsequent to the first scan period.

The method according to this embodiment may comprise:

calculating a difference between the input grayscale data and the grayscale data of one scan line read from the display memory in dot units;

calculating a correction value corresponding to the difference; and

generating the corrected data based on the input grayscale data and the correction value.

The method according to this embodiment may comprise:

generating a second vertical synchronization signal which provides reference timing for driving the electro-optical device based on a first vertical synchronization signal input together with the input grayscale data; and

driving the electro-optical device based on the corrected data on condition that the first vertical synchronization signal has been input, and then driving the electro-optical device based on the grayscale data read from the display memory in synchronization with the second vertical synchronization signal.

The embodiments are described below in detail with reference to the drawings.

1. Liquid Crystal Device

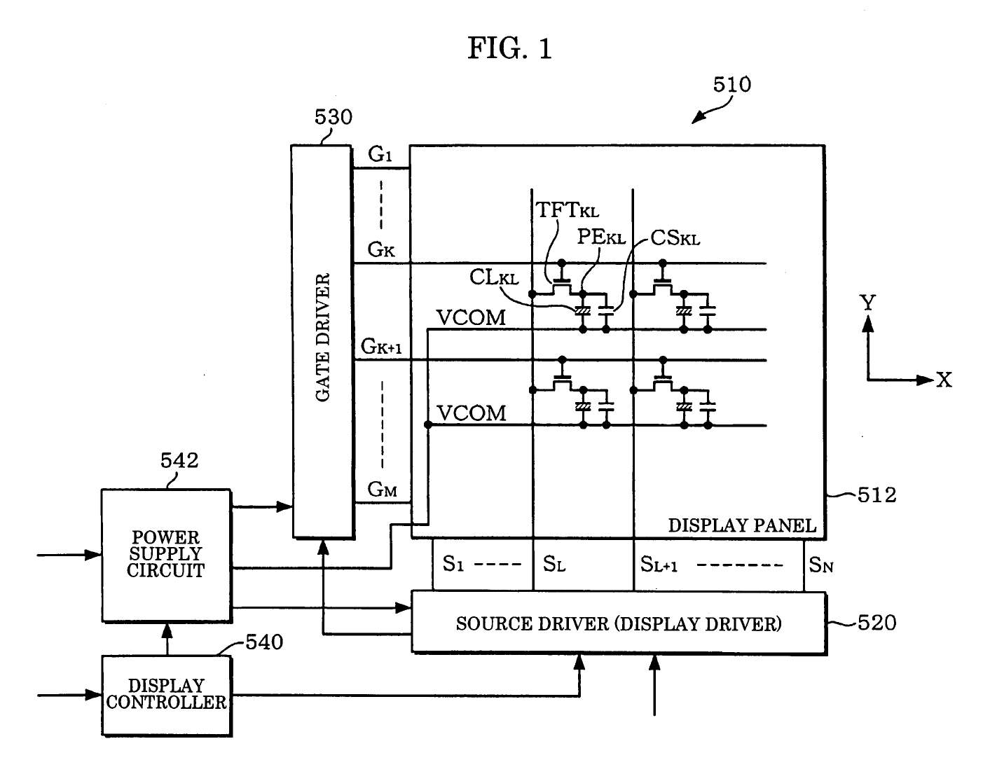

FIG. 1 shows an example of a block diagram of a liquid crystal device according to this embodiment. In FIG. 1, a display panel which is a liquid crystal panel is used as an electro-optical device.

A liquid crystal device (display device in a broad sense) 510 includes a display panel (electro-optical device in a broad sense) 512, a source driver (display driver in a broad sense; data line driver circuit in a narrow sense) 520, a gate driver (scan driver or gate line driver circuit) 530, a display controller 540, and a power supply circuit 542. The liquid crystal device 510 need not necessarily include all of these circuit blocks. The liquid crystal device 510 may have a configuration in which some of these circuit blocks are omitted.

The display panel 512 includes a plurality of gate lines (scan lines in a broad sense), a plurality of source lines (data lines in a broad sense), and pixels (pixel electrodes) specified by the gate lines and the source lines. In this case, an active matrix type liquid crystal device may be formed by connecting a thin film transistor TFT (switching element in a broad sense) with the source line and connecting the pixel electrode with the thin film transistor TFT.

In more detail, the display panel 512 is formed on an active matrix substrate (e.g. glass substrate). A plurality of gate lines G₁ to G_{M} (M is a positive integer of two or more), arranged in a direction Y in FIG. 1 and extending in a direction X, and a plurality of source lines S₁ to S_{N} (N is a positive integer of two or more), arranged in the direction X and extending in the direction Y, are disposed on the active matrix substrate. A thin film transistor TFT_{KL} (switching element in a broad sense) is provided at a position corresponding to the intersection of the gate line G_{K} (1≦K≦M, K is a positive integer) and the source line S_{L} (1≦L≦N, L is a positive integer).

The gate of the thin film transistor TFT_{KL} is connected with the gate line G_{K}, the source of the thin film transistor TFT_{KL} is connected with the source line S_{L}, and the drain of the thin film transistor TFT_{KL} is connected with a pixel electrode PE_{KL}. A liquid crystal capacitor CL_{KL} (liquid crystal element) and a storage capacitor CS_{KL} are formed between the pixel electrode PE_{KL} and a common electrode VCOM opposite to the pixel electrode PE_{KL} through a liquid crystal element (electro-optical material in a broad sense). A liquid crystal is sealed between the active matrix substrate, on which the thin film transistor TFT_{KL}, the pixel electrode PE_{KL}, and the like are formed, and a common substrate on which the common electrode VCOM is formed. The transmissivity of the pixel changes depending on the voltage applied between the pixel electrode PE_{KL} and the common electrode VCOM.

A voltage applied to the common electrode VCOM is generated by the power supply circuit 542. The common electrode VCOM may be formed in a stripe pattern corresponding to each gate line instead of forming the common electrode VCOM over the entire common substrate.

The source driver 520 drives the source lines S₁ to S_{N} of the display panel 512 based on grayscale data. The gate driver 530 sequentially scans the gate lines G₁ to G_{M} of the display panel 512.

The display controller 540 controls the source driver 520, the gate driver 530, and the power supply circuit 542 according to the content set by a host (not shown) such as a central processing unit (CPU).

In more detail, the display controller 540 or the host supplies an operation mode setting of the source driver 520 and the gate driver 530 and a horizontal synchronization signal and a vertical synchronization signal generated therein to the source driver 520, and controls the polarity reversal timing of the voltage of the common electrode VCOM for the power supply circuit 542, for example. The source driver 520 supplies a gate driver control signal corresponding to the content set by the display controller 540 or the host to the gate driver 530, and the gate driver 530 is controlled based on the gate driver control signal. The source driver 520 is informed of the polarity reversal timing of the voltage of the common electrode VCOM. The source driver 520 generates a polarity reversal signal POL described later in synchronization with the polarity reversal timing.

The power supply circuit 542 generates voltages necessary for driving the display panel 512 and the voltage of the common electrode VCOM based on a reference voltage supplied from the outside.

In FIG. 1, the liquid crystal device 510 includes the display controller 540. Note that the display controller 540 may be provided outside the liquid crystal device 510. Or, the host may be provided in the liquid crystal device 510 together with the display controller 540. Some or all of the source driver 520, the gate driver 530, the display controller 540, and the power supply circuit 542 may be formed on the display panel 512.

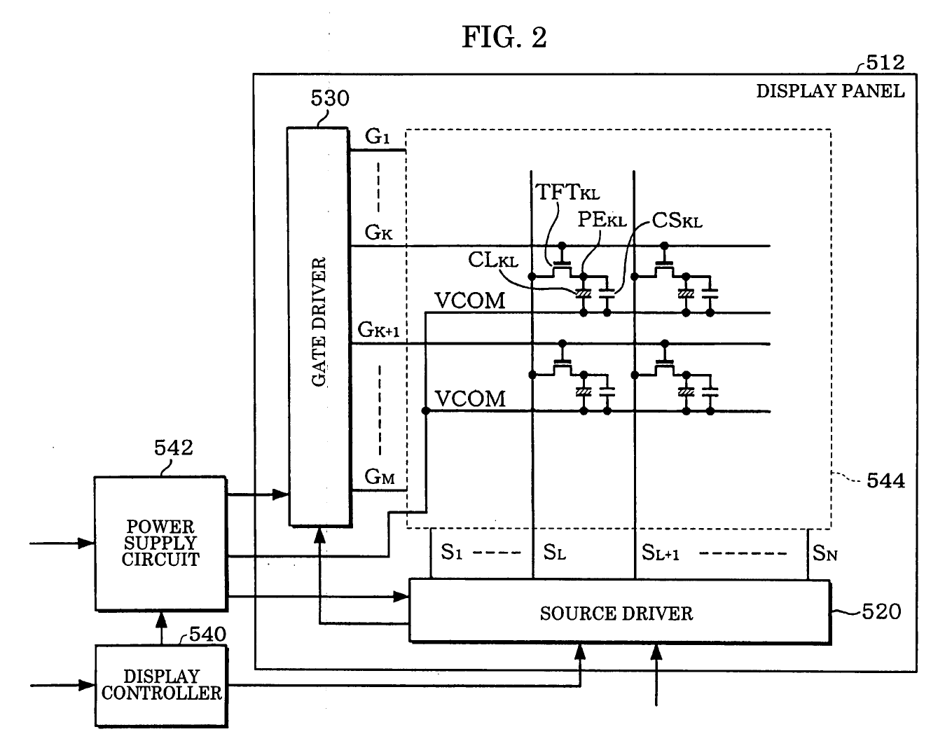

FIG. 2 is a block diagram of another configuration example of the liquid crystal device according to this embodiment.

In FIG. 2, the source driver 520 and the gate driver 530 are formed on the display panel 512 (on a panel substrate). Specifically, the display panel 512 may be configured to include a plurality of source lines, a plurality of gate lines, a plurality of pixels connected with the gate lines and the source lines, a source driver which drives the source lines, and a gate driver which scans the gate lines. The pixels are formed in a pixel formation region 544 of the display panel 512.

In FIG. 2, the gate driver 530 may not be formed on the display panel 512. In FIG. 2, at least one of the power supply circuit 542 and the display controller 540 may be formed on the display panel 512.

2. Gate Driver

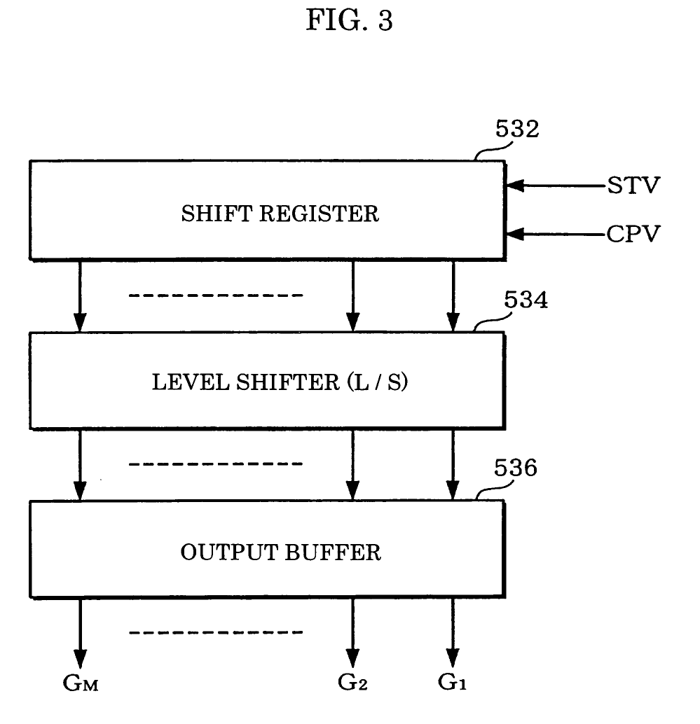

FIG. 3 is a block diagram of a configuration example of the gate driver 530 shown in FIG. 1 or 2.

The gate driver 530 includes a shift register 532, a level shifter 534, and an output buffer 536.

The shift register 532 includes a plurality of flip-flops provided corresponding to the gate lines and sequentially connected. The shift register 532 holds a start pulse signal STV in the flip-flop in synchronization with a clock signal CPV from the source driver 520, and sequentially shifts the start pulse signal STV to the adjacent flip-flops in synchronization with the clock signal CPV. The input start pulse signal STV is a vertical synchronization signal from the source driver 520.

The level shifter 534 shifts the level of the voltage from the shift register 532 to the voltage level corresponding to the liquid crystal element of the display panel 512 and the transistor performance of the thin film transistor TFT. A high voltage level of 20 to 50 V is necessary, for example.

The output buffer 536 buffers the scan voltage shifted by the level shifter 534, and drives the gate line by outputting the scan voltage to the gate line.

3. Source Driver

The display driver according to this embodiment is applied as the source driver 520 shown in FIG. 1 or 2.

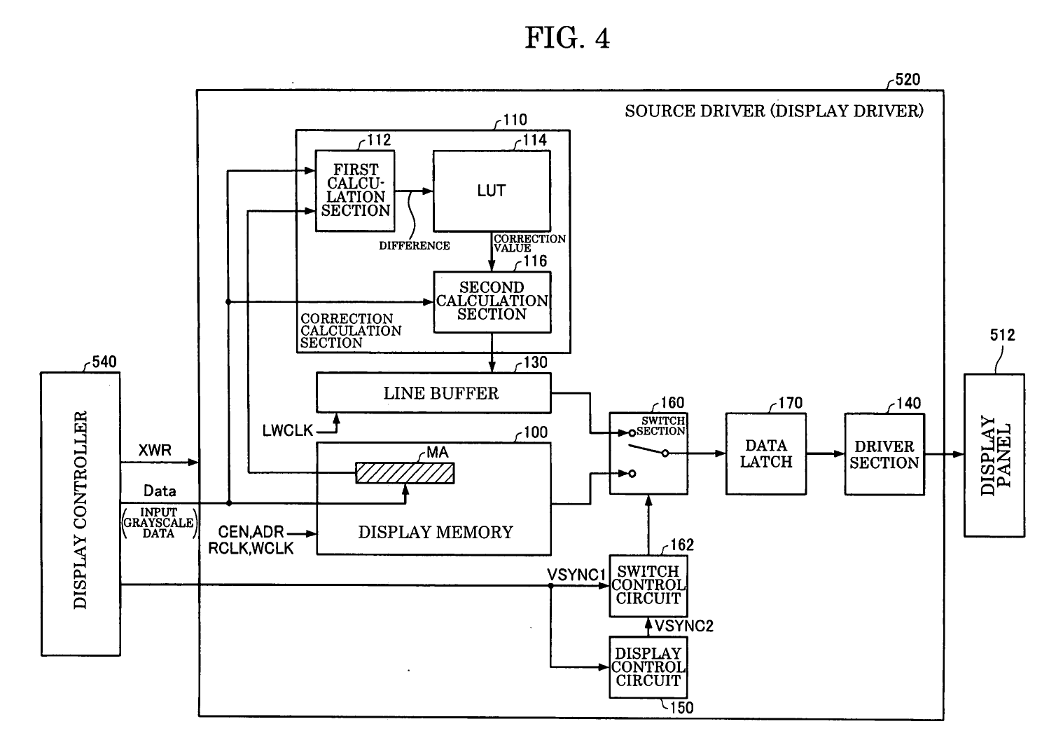

FIG. 4 is a block diagram of a configuration example of the source driver as the display driver according to this embodiment. In FIG. 4, the same sections as in FIG. 1 or 2 are indicated by the same symbols. Description of these sections is appropriately omitted.

The source driver 520 drives the display panel 512 as an electro-optical device based on grayscale data. The source driver 520 includes a display memory 100, a correction calculation section 110, a line buffer 130, and a driver section 140. The grayscale data of at least one frame is stored in the display memory 100. The display controller 540 periodically writes the grayscale data of at least one frame into the display memory 100 as input grayscale data. The correction calculation section 110 corrects the input grayscale data supplied to the display memory 100 in units of dots forming one pixel. The corrected data of one scan line (one horizontal scan period) corrected by the correction calculation section 110 is stored in the line buffer 130. The driver section 140 drives the display panel 512 (source lines of the display panel 512) based on the grayscale data read from the display memory 100 or the corrected data read from the line buffer 130.

The source driver 520 detects that the input grayscale data has started to be supplied from the display controller 540. The source driver 520 detects that the input grayscale data has started to be supplied based on a vertical synchronization signal VSYNC1 (first vertical synchronization signal) input from the display controller 540 in synchronization with the input grayscale data, for example.

The correction calculation section 110 reads the grayscale data of one scan line from the display memory 100 on condition that the input grayscale data has been supplied from the display controller 540 (on condition that supplying of the input grayscale data has commenced), and generates corrected data based on the grayscale data and the input grayscale data of one scan line. The grayscale data of one scan line read from the display memory 100 is the grayscale data of a frame at least one frame before the current frame.

In more detail, the correction calculation section 110 calculates the difference between the input grayscale data and the grayscale data of one scan line read from the display memory 100 in dot units, and calculates the correction value corresponding to the difference. The correction calculation section 110 generates corrected data based on the input grayscale data and the correction value. The correction calculation section 110 may include a first calculation section 112, a look-up table (LUT) 114, and a second calculation section 116.

The first calculation section 112 calculates the difference between the input grayscale data and the grayscale data of one scan line read from the display memory 100 in dot units. The correction value is stored in the LUT 114 corresponding to the difference calculated by the first calculation section 112. The second calculation section 116 generates corrected data based on the input grayscale data and the correction value. The corrected data thus generated is stored in the line buffer 130.

The input grayscale data from the display controller 540 is subjected to correction calculation by the correction calculation section 110 and is also stored in a memory area MA of the display memory 100 in which the grayscale data of one scan line read by the correction calculation section 110 has been stored. Therefore, the input grayscale data stored in the display memory 100 is subjected to the subsequent correction calculation by the correction calculation section 110.

The driver section 140 drives the display panel 512 based on the corrected data in a first scan period, and drives the display panel 512 based on the grayscale data read from the display memory 100 in each of one or more scan periods subsequent to the first scan period.

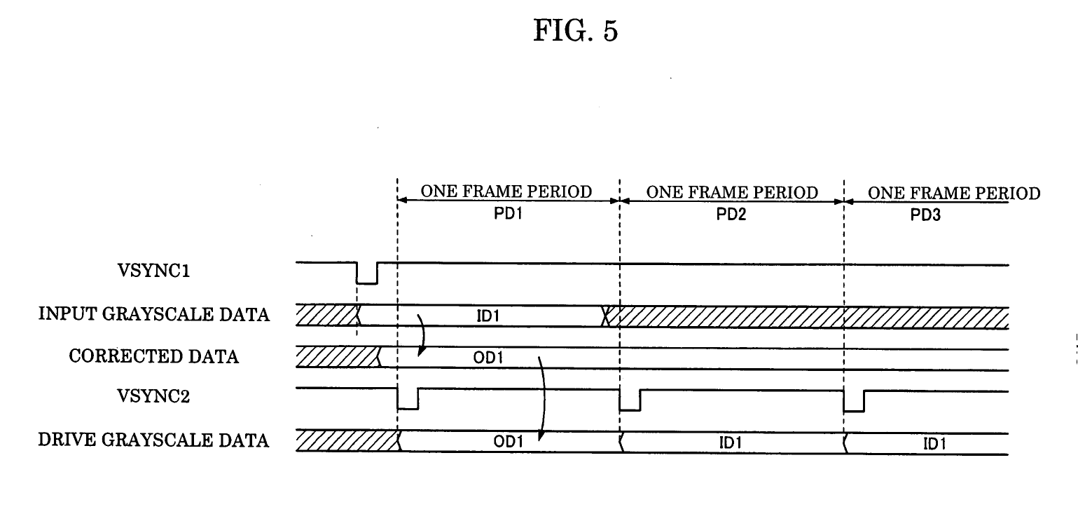

FIG. 5 shows the timing of an operation example of the source driver 520 shown in FIG. 4. FIG. 5 shows changes in grayscale data for the driver section 140 to drive the display panel 512.

In FIG. 4, the source driver 520 may further include a display control circuit 150. The vertical synchronization signal VSYNC1 (first vertical synchronization signal) from the display controller 540 is input to the display control circuit 150. The vertical synchronization signal VSYNC1 is a synchronization signal which specifies one vertical scan period of the input grayscale data from the display controller 540. The display control circuit 150 generates a vertical synchronization signal VSYNC2 (second vertical synchronization signal) which provides reference timing for the driver section 140 to drive the display panel 512 based on the vertical synchronization signal VSYNC1 (first vertical synchronization signal).

In more detail, the image size (number of dots of each scan line and number of scan lines) of one frame of the input grayscale data is set in the display control circuit 150 of the source driver 520 by the display controller 540. The display control circuit 150 generates the vertical synchronization signal VSYNC2 based on the image size.

When input grayscale data ID1 is input from the display controller 540 together with the vertical synchronization signal VSYNC1 (first vertical synchronization signal), the correction calculation section 110 calculates the difference between the input grayscale data of one scan line and the grayscale data of one scan line read from the display memory 100 in dot units, and calculates the correction value corresponding to the difference. The correction calculation section 110 generates corrected data OD1 based on the input grayscale data and the correction value. The input grayscale data ID1 is stored in the display memory 100.

The driver section 140 drives the display panel 512 based on the corrected data OD1 in a first scan period PD1 specified by the vertical synchronization signal VSYNC2 (second vertical synchronization signal). In each of second and third scan periods PD2 and PD3 subsequent to the first scan period PD1, the driver section 140 drives the display panel 512 based on the grayscale data (input grayscale data ID1 stored in the display memory 100) read from the display memory 100.

In more detail, the source driver 520 may include a switch section 160 and a switch control circuit 162. The switch section 160 outputs the corrected data from the line buffer 130 to the driver section 140 or outputs the grayscale data from the display memory 100 to the driver section 140 under switch control of the switch control circuit 162.

The switch control circuit 162 causes the switch section 160 to output the corrected data from the line buffer 130 to the driver section 140 in synchronization with the vertical synchronization signal VSYNC1 in at least a period corresponding to the number of dots of each scan line of the input grayscale data and the number of scan lines. The switch control circuit 162 then causes the switch section 160 to output the grayscale data from the display memory 100 to the driver section 140 in a vertical scan period specified by the vertical synchronization signal VSYNC2. Specifically, the switch control circuit 162 causes the corrected data to be output to the driver section 140 on condition that the vertical synchronization signal VSYNC1 has become active, and causes the grayscale data from the display memory 100 to be output to the driver section 140 in synchronization with the vertical synchronization signal VSYNC2 until the vertical synchronization signal VSYNC1 again becomes active.

As described above, the driver section 140 drives the display panel 512 based on the corrected data in the first scan period PD1 on condition that the vertical synchronization signal VSYNC1 (first vertical synchronization signal) has been input, and drives the display panel 512 based on the grayscale data read from the display memory 100 in synchronization with the vertical synchronization signal VSYNC2 (second vertical synchronization signal).

The source driver 520 may include a data latch 170. The data latch 170 holds the grayscale data read from the display memory 100 or the corrected data read from the line buffer 130. In this case, the driver section 140 drives the display panel 512 using the data (grayscale data or corrected data) held by the data latch 170. As a result, corrected data for the next scan period can be provided during the period in which the driver section 140 drives the display panel 512. Therefore, a sufficient driving time can be provided for the driver section 140.

3.1 Correction Calculation

The correction calculation section 110 according to this embodiment is described below.

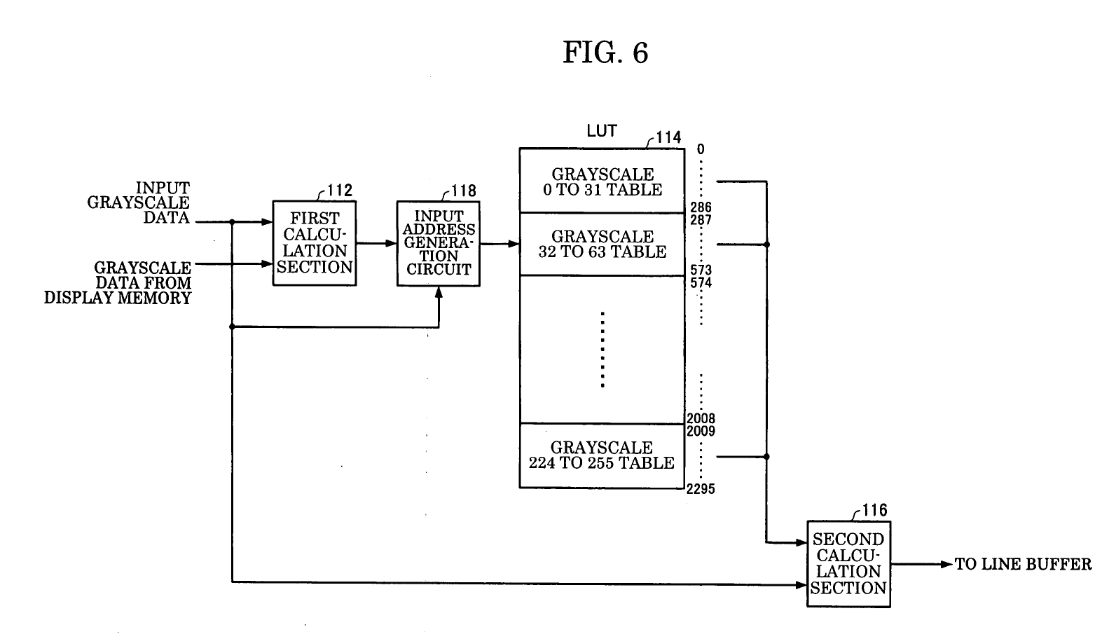

FIG. 6 shows an outline of a configuration of the correction calculation section shown in FIG. 4.

The correction calculation section 110 reads the grayscale data of one scan line from the display memory 100, calculates the difference between the input grayscale data of one scan line and the grayscale data of one scan line read from the display memory 100 in dot units, and calculates the correction value corresponding to the difference. The correction calculation section 110 generates corrected data based on the input grayscale data and the correction value.

It is preferable that a different correction value be stored in the LUT 114 corresponding to the input grayscale data even if the difference is the same.

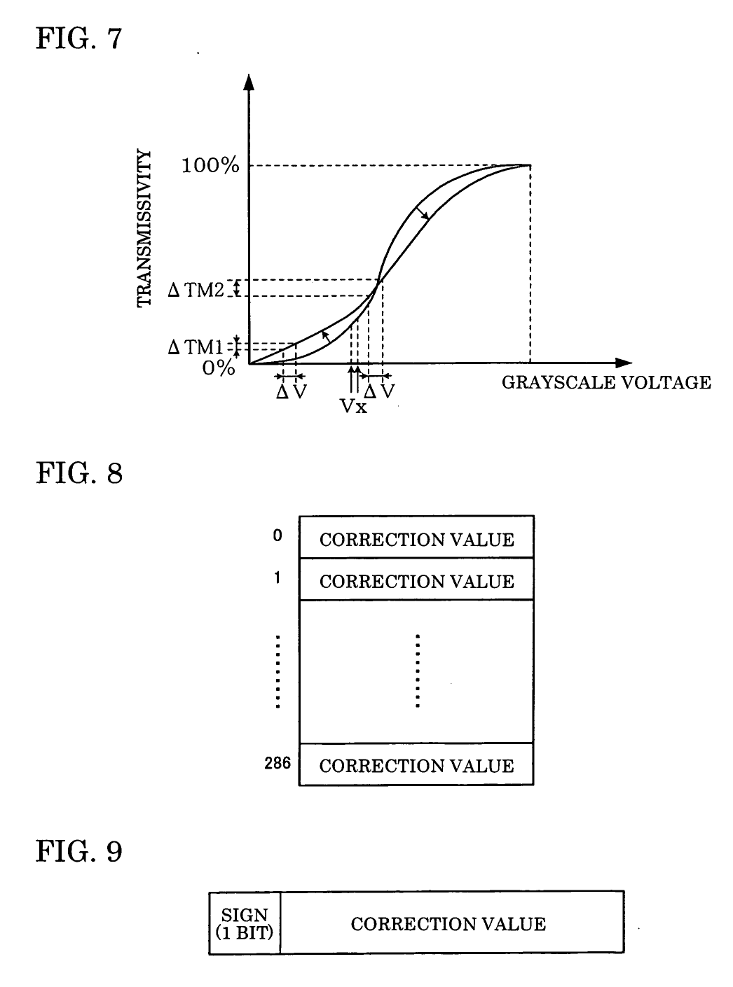

FIG. 7 is a view illustrative of the grayscale characteristics of the display panel.

In FIG. 7, the horizontal axis indicates the grayscale voltage, and the vertical axis indicates the transmissivity of the pixel. The grayscale voltage corresponds to the grayscale indicated by the corrected data or the input grayscale data. Since the grayscale voltage can be easily changed corresponding to the corrected data, the transmissivity of the pixel of the display panel can be easily changed by adjusting the corrected data generated by the correction calculation section 110. Therefore, the grayscale characteristics can be flexibly changed using a simple configuration.

As shown in FIG. 7, the transmissivity of the pixel and the grayscale voltage do not have a linear relationship. Therefore, a change ΔTM1 in transmissivity accompanying a change in voltage ΔV in a low grayscale voltage region differs from a change ΔTM2 in transmissivity accompanying a change in voltage ΔV in an intermediate grayscale voltage region.

The voltage ΔV corresponds to the correction value from the LUT 114. Therefore, even if the difference calculated by the first calculation section 112 is the same, it is preferable that a different correction value be stored depending on the grayscale indicated by the input grayscale data according to the grayscale characteristics shown in FIG. 7.

Therefore, the grayscales indicated by the input grayscale data are divided into a plurality of blocks, and the correction values are stored in the LUT 114 shown in FIG. 6 in block units. In FIG. 6, 256 grayscales indicated by the input grayscale data are divided into eight blocks, for example. Specifically, the grayscales are divided into grayscales 0 to 31, grayscales 32 to 63, grayscales 64 to 95, . . . , and grayscales 224 to 225, and a grayscale table is provided for each block. The above correction value is stored in the grayscale table. In FIG. 6, the correction value when the grayscale indicated by the input grayscale data is in the range of the grayscales 0 to 31 is stored in the grayscale 0 to 32 table, and the correction value when the grayscale indicated by the input grayscale data is in the range of the grayscales 32 to 63 is stored in the grayscale 32 to 63 table, for example.

Therefore, a single correction value is used for the grayscales 0 to 31 so that the same correction value is output for the same difference. On the other hand, the correction value corresponding to the difference when the grayscale indicated by the input grayscale data is in the range of the grayscales 0 to 31 differs from the correction value corresponding to the difference when the grayscale indicated by the input grayscale data is in the range of the grayscales 32 to 63. As a result, corrected data can be adjusted according to the grayscale characteristics.

In FIG. 6, the correction calculation section 110 may include an input address generation circuit 118. The input address generation circuit 118 generates an input address of the LUT 114 based on the difference calculated by the first calculation section 112 corresponding to the input grayscale data. The LUT 114 outputs the correction value corresponding to the input address.

FIG. 8 is a view illustrative of the grayscale 0 to 31 table of the LUT 114 shown in FIG. 6.

The correction value is stored in the grayscale 0 to 31 table corresponding to each of input addresses “0” to “286”, for example. Although FIG. 8 shows only the grayscale 0 to 31 table, the grayscale tables for other blocks such as the grayscale 32 to 64 table have the same configuration as that of the grayscale 0 to 31 table except that different input addresses are assigned to each grayscale table.

FIG. 9 is a view illustrative of the correction value shown in FIG. 8 in detail.

A 1-bit sign bit and the correction value are stored corresponding to each address specified by the input address. The second calculation section 116 performs addition processing of the input grayscale data using the sign bit and the correction value output corresponding to the input address. The second calculation section 116 performs subtraction processing of the input grayscale data and the correction value when the sign bit indicates negative, and performs addition processing of the input grayscale data and the correction value when the sign bit indicates positive.

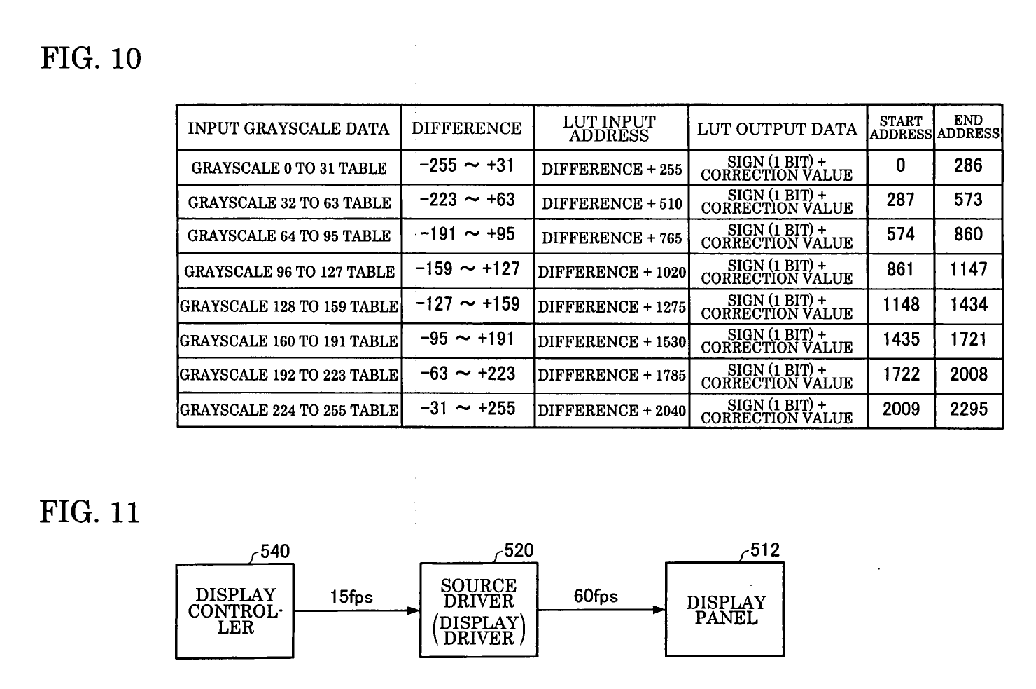

FIG. 10 is a view illustrative of an example of the correction value stored in the LUT 114 according to this embodiment.

In FIG. 10, a region assigned from the start address “0” to the end address “286” is provided in the LUT 114 as the grayscale 0 to 31 table, and a region assigned from the start address “287” to the end address “573” is provided in the LUT 114 as the grayscale 32 to 63 table, for example.

The input address generation circuit 118 determines the group based on the input grayscale data. Specifically, the input address generation circuit 188 determines the grayscale table based on the input grayscale data. The input address generation circuit 188 has an addition value corresponding to each grayscale table, and generates the input address by adding the addition value corresponding to the determined grayscale table to the difference calculated by the first calculation section 112. For example, when the grayscale indicated by the input grayscale data is in the range of the grayscales 0 to 31, the range of the difference calculated by the first calculation section 112 is −255 to +31. Accordingly, the input address of the grayscale 0 to 31 table of the LUT 114 corresponding to the difference is calculated by adding the difference and the addition value “255”. Likewise, when the grayscale indicated by the input grayscale data is in the range of the grayscales 32 to 63, the range of the difference calculated by the first calculation section 112 is −223 to +63. Accordingly, the input address of the grayscale 32 to 63 table of the LUT 114 corresponding to the difference is calculated by adding the difference and the addition value “510”.

3.2 Outline of Operation

FIG. 11 is a schematic view of a connection example of the source driver 520 shown in FIG. 4.

For example, the input grayscale data from the display controller 540 is input at a rate of 15 flames per second (fps), and the source driver 520 drives the display panel 512 at a rate of 60 fps. In this case, the source driver 520 must drive the display panel 512 by repeatedly using the input grayscale data of one frame.

In this case, a source driver in a comparative example of this embodiment drives the source line as follows.

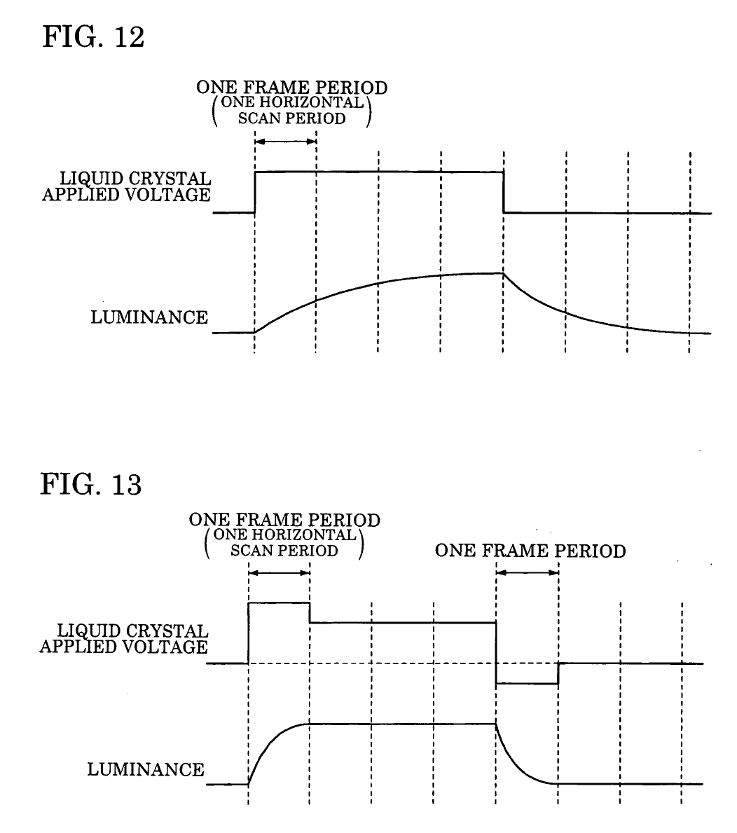

FIG. 12 shows an example of a change in the luminance of the pixel driven by the source driver in the comparative example of this embodiment.

The source driver in the comparative example supplies the grayscale voltage corresponding to the input grayscale data to the source line in each of four (=60/15) frames. In this case, a constant grayscale voltage is continuously supplied to the liquid crystal connected with the source line through the thin film transistor TFT in each frame. However, when the liquid crystal exhibits a low response speed, a desired luminance may not be achieved even after the four frames have elapsed. Therefore, a residual image occurs when displaying a video image, whereby the image quality deteriorates.

On the other hand, the source driver according to this embodiment drives the source line as follows.

FIG. 13 shows an example of a change in the luminance of the pixel driven by the source driver according to this embodiment.

The source driver 520 according to this embodiment drives the source line so that a voltage corrected to be higher than the original liquid crystal applied voltage is applied to the liquid crystal in the first frame of the four frames. The corrected voltage may be a voltage corresponding to the corrected data. The source driver 520 supplies the original liquid crystal applied voltage to the source line in the second and subsequent frames of the four frames. Specifically, the grayscale voltage corresponding to the corrected data is applied to the source line of the display panel 512 in the first scan period, and the grayscale voltage corresponding to the grayscale data read from the display memory 100 is applied to the source line of the display panel 512 in one or more scan periods subsequent to the first scan period. Therefore, a highly accurate grayscale representation can be achieved by increasing the response speed of the liquid crystal and then applying an accurate grayscale voltage so that the luminance corresponding to the original grayscale is obtained.

In FIG. 13, the source line is driven so that a voltage corrected to be higher than the original liquid crystal applied voltage is also applied to the liquid crystal in the first of the subsequent four frames.

Since it suffices that the correction calculation section 110 operate only when the input grayscale data is supplied, an increase in power consumption can be suppressed. Therefore, power consumption can be reduced as the supply rate of the input grayscale data from the display controller 540 becomes lower.

In this embodiment, a desired grayscale representation can be achieved by allowing the corrected data to be adjusted corresponding to the grayscale characteristics of the display panel 512.

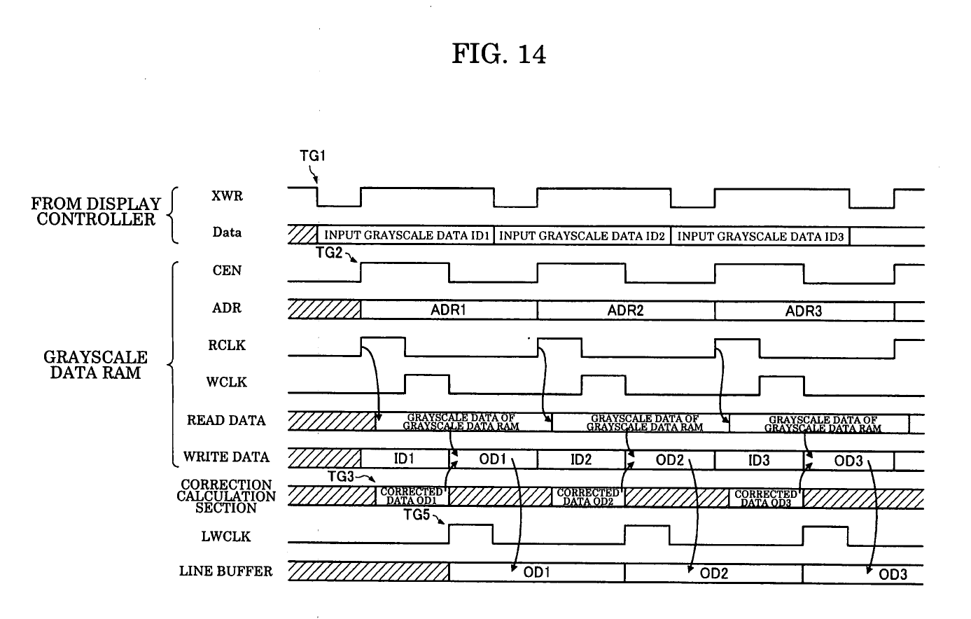

FIG. 14 is a timing diagram of a detailed operation example of the source driver 520 shown in FIG. 4.

The display controller 540 outputs data Data and a write control signal XWR for writing the data Data to the source driver 520. The input grayscale data is transmitted to the source driver 520 as the data Data in frame units.

The source driver 520 includes a memory control circuit (not shown). The memory control circuit generates a chip enable signal CEN, a memory address signal ADR, a read clock signal RCLK, and a write clock signal WCLK for the display memory 100. The source driver 520 also includes a line buffer control circuit (not shown). The line buffer control circuit generates a write clock signal LWCLK for the line buffer 130.

When the display controller 540 has activated the write control signal XWR and started to supply the input grayscale data ID1 to the source driver 520 (TG1), the chip enable signal CEN and the read clock signal RCLK are activated in the source driver 520 (TG2), whereby the grayscale data of one scan line is read from the display memory 100.

The correction calculation section 110 calculates the difference between the input grayscale data of one scan line and the grayscale data of one scan line from the display memory 100 in dot units, and generates the corrected data OD1 by reflecting the correction value corresponding to the difference in the input grayscale data (TG3).

When the grayscale data has been read from the display memory 100, the memory control circuit inactivates the read clock signal RCLK and activates the write clock signal WCLK (TG4) to write the input grayscale data ID1 into the memory area of the display memory 100 in which the grayscale data read from the display memory 100 has been stored.

The line buffer control circuit then activates the write clock signal LWCLK to write the corrected data OD1 from the correction calculation section 110 into the line buffer 130 (TG5).

The above-described control is performed each time the input grayscale data is written from the display controller 540.

The response speed of the liquid crystal is thus increased by driving the display panel using the corrected data stored in the line buffer 130 only in the first frame.

3.3 Detailed Configuration Example of Source Driver

A hardware configuration example of the source driver according to this embodiment is described below.

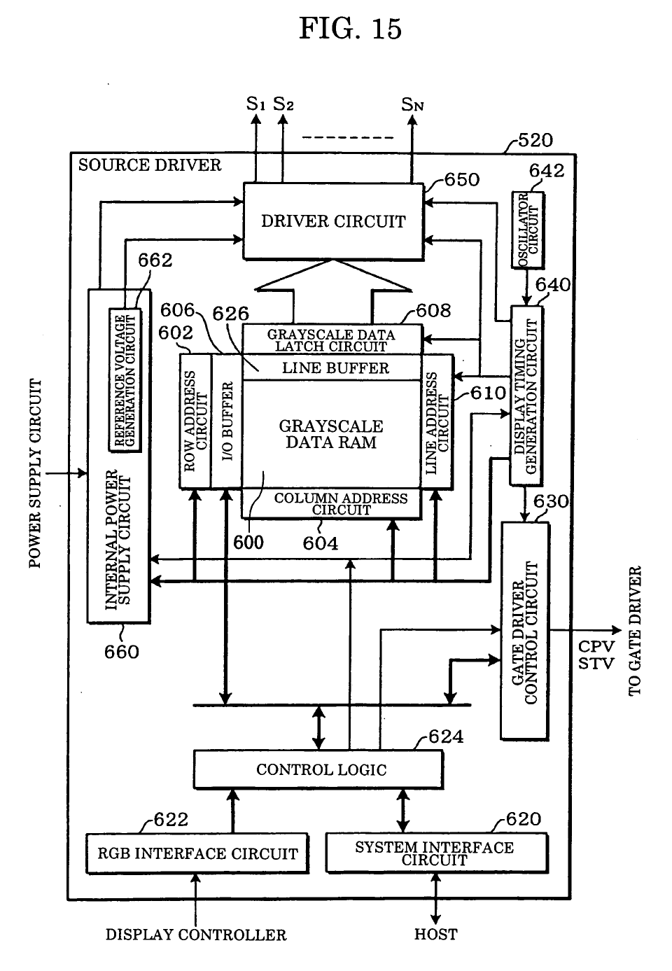

FIG. 15 shows a detailed configuration example of the source driver 520 shown in FIG. 4.

The source driver 520 includes a grayscale data random access memory (RAM) 600 as the display memory. The grayscale data of a still image or a video image is stored in the grayscale data RAM 600. The grayscale data RAM 600 stores the grayscale data of at least one frame. The host directly transfers the grayscale data of a still image to the source driver 520, for example. The display controller 540 transfers the grayscale data of a video image to the source driver 520, for example.

The function of the display memory 100 shown in FIG. 4 is realized by the grayscale data RAM 600. The grayscale data RAM 600 includes as a line buffer 626 a memory area in which the corrected data of at least one scan line is held. The function of the line buffer 130 shown in FIG. 4 is realized by the line buffer 626.

The source driver 520 includes a system interface circuit 620 for interfacing between the source driver 520 and the host. The system interface circuit 620 performs interface processing of signals transmitted and received between the source driver 520 and the host so that the host can set the control command or the grayscale data of a still image in the source driver 520 or read the status of the source driver 520 or data from the grayscale data RAM 600 through the system interface circuit 620.

The source driver 520 includes an RGB interface circuit 622 for interfacing between the source driver 520 and the display controller 540. The RGB interface circuit 622 performs interface processing of signals transmitted and received between the source driver 520 and the display controller 540 so that the display controller 540 can set the grayscale data of a video image in the source driver 520 through the RGB interface circuit 622.

The system interface circuit 620 and the RGB interface circuit 622 are connected with a control logic 624. The control logic 624 is a circuit block which controls the entire source driver 520. The control logic 624 writes the grayscale data input through the system interface circuit 620 or the RGB interface circuit 622 into the grayscale data RAM 600.

The control logic 624 decodes the control command input from the host through the system interface circuit 620 and outputs the control signal corresponding to the decode result to control each section of the source driver 520. For example, when the control command directs reading data from the grayscale data RAM 600, the control logic 624 outputs the grayscale data read from the grayscale data RAM 600 by read control to the host through the system interface circuit 620. The control logic 624 has the functions of the correction calculation section 110 shown in FIG. 4, the memory control circuit which controls access to the display memory 100, and the line buffer control circuit which controls access to the line buffer.

The source driver 520 includes a display timing generation circuit 640 and an oscillator circuit 642. The display timing generation circuit 640 generates timing signals for a grayscale data latch circuit 608, a line address circuit 610, a driver circuit 650, and a gate driver control circuit 630 from a display clock signal generated by the oscillator circuit 642.

The function of the display control circuit 150 shown in FIG. 4 is realized by the display timing generation circuit 640. The function of the data latch 170 shown in FIG. 4 is realized by the grayscale data latch circuit 608. The function of the driver section 140 shown in FIG. 4 is realized by the driver circuit 650. The functions of the switch section 160 and the switch control circuit 162 shown in FIG. 4 are realized by the control logic 624, the display timing generation circuit 640, the line address circuit 610, and a column address circuit 604.

The gate driver control circuit 630 outputs a gate driver control signal for driving the gate driver 530 corresponding to the control command input from the host through the system interface circuit 620.

The memory area of the grayscale data stored in the grayscale data RAM 600 is specified using a row address and a column address. The row address is designated by a row address circuit 602. The column address is designated by the column address circuit 604. The grayscale data input through the system interface circuit 620 or the RGB interface circuit 622 is buffered by an I/O buffer circuit 606, and written into the memory area of the grayscale data RAM 600 specified by the row address and the column address. The grayscale data read from the memory area of the grayscale data RAM 600 specified by the row address and the column address is buffered by the I/O buffer circuit 606, and output through the system interface circuit 620.

The line address circuit 610 designates the line address for reading the grayscale data output to the driver circuit 650 from the grayscale data RAM 600 in synchronization with the clock signal CPV in one horizontal scan period cycle from the gate driver control circuit 630. The grayscale data read from the grayscale data RAM 600 is latched by the grayscale data latch circuit 608, and output to the driver circuit 650.

The driver circuit 650 includes a plurality of driver output circuits provided in units of outputs to the source lines. Each driver output circuit includes an impedance conversion circuit. The impedance conversion circuit includes a voltage follower circuit, and drives the source line based on the grayscale voltage corresponding to the grayscale data from the grayscale data latch circuit 608.

The source driver 520 includes an internal power supply circuit 660. The internal power supply circuit 660 generates voltages necessary for a liquid crystal display using the power supply voltages supplied from the power supply circuit 542. The internal power supply circuit 660 includes a reference voltage generation circuit 662. The reference voltage generation circuit 662 generates a plurality of grayscale voltages by dividing the voltage between a high-potential-side power supply voltage (system power supply voltage) VDD and a low-potential-side power supply voltage (system ground power supply voltage) VSS. For example, when the grayscale data per dot is eight bits, the reference voltage generation circuit 662 generates 256 (=2⁸) grayscale voltages. Each grayscale voltage is associated with the grayscale data. The driver circuit 650 selects one of the grayscale voltages generated by the reference voltage generation circuit 662 based on the digital grayscale data from the grayscale data latch circuit 608, and outputs an analog grayscale voltage corresponding to the digital grayscale data to the driver output circuit. The impedance conversion circuit of the driver output circuit buffers the grayscale voltage and outputs the grayscale voltage to the source line to drive the source line. In more detail, the driver circuit 650 includes the impedance conversion circuits provided in source line units. The voltage follower circuit of each impedance conversion circuit subjects the grayscale voltage to impedance conversion, and outputs the resulting voltage to each source line.

4. Electronic Instrument

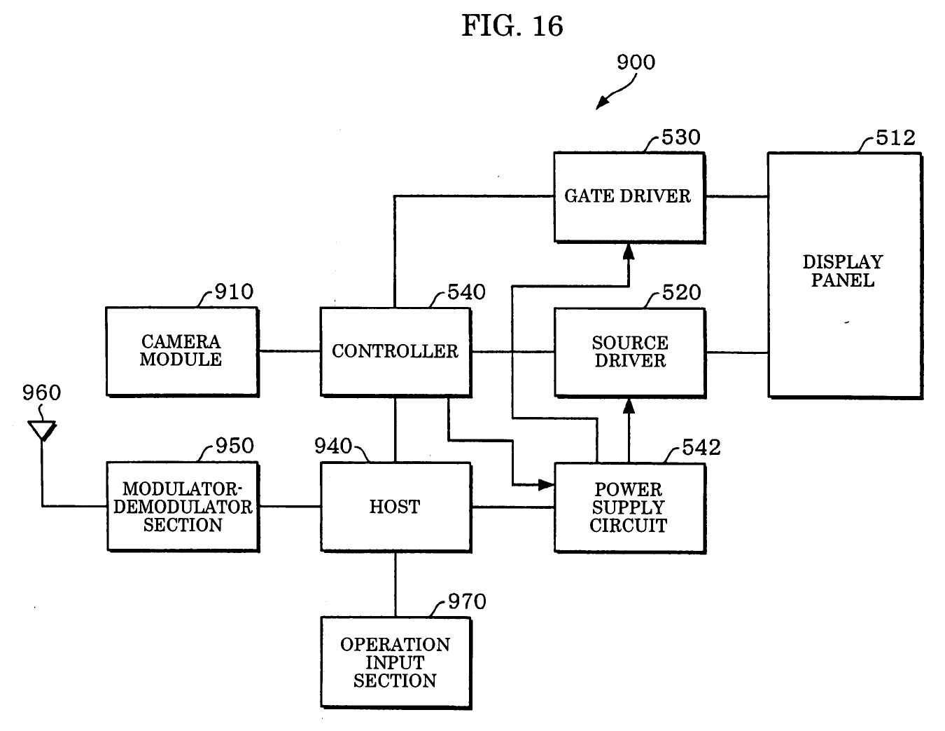

FIG. 16 is a block diagram of a configuration example of an electronic instrument according to this embodiment. FIG. 16 is a block diagram of a configuration example of a portable telephone as an example of the electronic instrument. In FIG. 16, the same sections as in FIG. 1 or 2 are indicated by the same symbols. Description of these sections is appropriately omitted.

A portable telephone 900 includes a camera module 910. The camera module 910 includes a CCD camera, and supplies data of an image captured using the CCD camera to the display controller 540 in a YUV format.

The portable telephone 900 includes the display panel 512. The display panel 512 is driven by the source driver 520 and the gate driver 530. The display panel 512 includes gate lines, source lines, and pixels.

The display controller 540 is connected with the source driver 520 and the gate driver 530, and supplies grayscale data in an RGB format to the source driver 520.

The power supply circuit 542 is connected with the source driver 520 and the gate driver 530, and supplies drive power supply voltages to each driver.

A host 940 is connected with the display controller 540. The host 940 controls the display controller 540. The host 940 demodulates grayscale data received through an antenna 960 using a modulator-demodulator section 950, and supplies the demodulated grayscale data to the display controller 540. The display controller 540 causes the source driver 520 and the gate driver 530 to display an image on the display panel 512 based on the grayscale data.

The host 940 modulates grayscale data generated by the camera module 910 using the modulator-demodulator section 950, and directs transmission of the modulated data to another communication device through the antenna 960.

The host 940 transmits and receives grayscale data, captures an image using the camera module 910, and displays an image on the display panel 512 based on operation information from an operation input section 970.

The invention is not limited to the above-described embodiments. Various modifications and variations may be made within the spirit and scope of the invention. For example, the invention may be applied not only to drive the liquid crystal panel, but also to drive an electroluminescent display device or a plasma display device.

Some of the requirements of any claim of the invention may be omitted from a dependent claim which depends on that claim. Some of the requirements of any independent claim of the invention may be allowed to depend on any other independent claim.

Although only some embodiments of the invention are described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A display driver for driving an electro-optical device based on grayscale data, the display driver comprising:
a display memory which stores grayscale data of at least one frame;
a correction calculation section which corrects input grayscale data supplied to the display memory in units of dots forming one pixel;
a line buffer which stores corrected data of one scan line corrected by the correction calculation section; and
a driver section which drives the electro-optical device based on the grayscale data read from the display memory or the corrected data read from the line buffer;
the correction calculation section reading the grayscale data of one scan line from the display memory, and generating the corrected data based on the grayscale data and the input grayscale data of one scan line, on condition that the input grayscale data has been supplied; and
the driver section driving the electro-optical device based on the corrected data in a first scan period, and driving the electro-optical device based on the grayscale data read from the display memory in each of one or more scan periods subsequent to the first scan period.

2. The display driver as defined in claim 1,
wherein the input grayscale data is stored in a memory area of the display memory in which the grayscale data of one scan line read by the correction calculation section has been stored.

3. The display driver as defined in claim 1,
wherein the correction calculation section calculates a difference between the input grayscale data and the grayscale data of one scan line read from the display memory in dot units, calculates a correction value corresponding to the difference, and generates the corrected data based on the input grayscale data and the correction value.

4. The display driver as defined in claim 3,
wherein the correction calculation section includes:
a first calculation section which calculates the difference between the input grayscale data and the grayscale data of one scan line read from the display memory in dot units;
a look-up table which stores the correction value corresponding to the difference; and
a second calculation section which generates the corrected data based on the input grayscale data and the correction value; and
wherein the corrected data generated by the second calculation section is stored in the line buffer.

5. The display driver as defined in claim 4,
wherein a different correction value is stored in the look-up table corresponding to the input grayscale data even if the difference is the same.

6. The display driver as defined in claim 5,
wherein an input address corresponding to the difference is generated corresponding to the input grayscale data; and
wherein the look-up table outputs the correction value corresponding to the input address.

7. The display driver as defined in claim 1, comprising:
a data latch which holds the grayscale data read from the display memory or the corrected data read from the line buffer;
wherein the driver section drives the electro-optical device using the data held by the data latch.

8. The display driver as defined in claim 1, comprising:
a display control circuit which generates a second vertical synchronization signal which provides reference timing for the driver section to drive the electro-optical device based on a first vertical synchronization signal input together with the input grayscale data;
wherein the driver section drives the electro-optical device based on the corrected data on condition that the first vertical synchronization signal has been input, and then drives the electro-optical device based on the grayscale data read from the display memory in synchronization with the second vertical synchronization signal.

9. An electro-optical device comprising:
a plurality of scan lines;
a plurality of data lines;
a plurality of pixels specified by the scan lines and the data lines;
a scan driver which scans the scan lines; and
the display driver as defined in claim 1 which drives the data lines based on the grayscale data.

10. An electronic instrument comprising the electro-optical device as defined in claim 9.

11. The electronic instrument as defined in claim 10, comprising:
a display controller which supplies to the display driver the input grayscale data and a first vertical synchronization signal in synchronization with the input grayscale data.

12. A method of driving a display driver for driving an electro-optical device based on grayscale data, the display driver including a display memory which stores grayscale data of at least one frame, the method comprising:
reading grayscale data of one scan line from the display memory on condition that input grayscale data has been supplied to the display memory;
generating corrected data by correcting the input grayscale data in units of dots forming one pixel based on the grayscale data and the input grayscale data of one scan line; and
driving the electro-optical device based on the corrected data in a first scan period, and driving the electro-optical device based on the grayscale data read from the display memory in each of one or more scan periods subsequent to the first scan period.

13. The method as defined in claim 12, comprising:
calculating a difference between the input grayscale data and the grayscale data of one scan line read from the display memory in dot units;
calculating a correction value corresponding to the difference; and
generating the corrected data based on the input grayscale data and the correction value.

14. The method as defined in claim 12, comprising:
generating a second vertical synchronization signal which provides reference timing for driving the electro-optical device based on a first vertical synchronization signal input together with the input grayscale data; and
driving the electro-optical device based on the corrected data on condition that the first vertical synchronization signal has been input, and then driving the electro-optical device based on the grayscale data read from the display memory in synchronization with the second vertical synchronization signal.
